(19) United States
(12) Patent Application Publication
(10) Pub. No.: US 2006/0202900 A1
(43) Pub. Date: Sep. 14, 2006

(54) Capacitively coupled log periodic dipole antenna

(75) Inventor: Arin Matthew Simile, Sugar Hill, GA (US)

Correspondence Address: MEHRMAN LAW OFFICE, P.C., ONE PREMIER PLAZA, 5605 GLENRIDGE DRIVE, STE. 795, ATLANTA, GA, 30342, US

(73) Assignee: EMS TECHNOLOGIES, INC.

(21) Appl. No.: 11/330,479

(22) Filed: Jan. 12, 2006

Related U.S. Application Data
(60) Provisional application No. 60/659,448, filed on Mar. 8, 2005.

(51) Int. Cl. H01Q 11/10

(52) U.S. Cl. 343/792.5

(57) ABSTRACT

A log periodic dipole antenna in which some, or preferably all, of the mechanical attachments do not include metal-to-metal contact points. In particular, the antenna elements, which are cantilevered from a ground plate, are mechanically supported by and capacitively coupled to the ground plate with a dielectric adhesive material, such as a sufficiently sturdy dielectric tape. Other attachments to the antenna element, such an antenna feed circuit and a signal coupler, may also be assembled with the dielectric adhesive material. This type of construction capacitively couples the operative elements of the antenna and avoids passive intermodulation (PIM) interference and electromechanical corrosion that is often caused by metal-to-metal attachment points.

### REFERENCE TO RELATED APPLICATION

This application claims the filing priority benefit of U.S. Provisional Patent Application Ser. No. 60/659,448 entitled “Capacitively Coupled Microstrip Fed Log Periodic Dipole Antenna and Antenna Array” filed on Mar. 8, 2005.

### FIELD OF THE INVENTION

The present invention relates to radio-frequency antennas, such as wireless telephone base station antennas. The invention relates more specifically to an antenna including log periodic dipole antenna elements mechanically supported by and capacitively coupled to a ground plate without the use of metal-to-metal fasteners.

### BACKGROUND OF THE INVENTION

Log periodic dipole antennas have been used as wireless telephone base station antennas for many years. These antennas typically include a one or two linear arrays of log periodic dipole antenna elements fastened to an elongated ground plate, which serves as the mechanical support panel for the antenna. The ground plate and antenna elements are covered by a radome and the antenna is typically mounted in a substantially vertical orientation, usually tilted slightly downward toward the horizon. Two or three antennas are typically mounted in a horizontal array, which gives the antennas the familiar panel antenna appearance seen on towers and buildings. In this configuration, the antenna elements extend substantially horizontally from the ground plate. In other words, the antenna elements are cantilevered from the substantially vertical ground plate, which serves as the mechanical support panel for the antenna elements.

Of course, the antenna elements must be mechanically supported by the ground plate in a sufficiently secure way to maintain the physical integrity of the antenna over its operational lifespan. To provide the required mechanical support in conventional log periodic dipole antennas, the cantilevered antenna elements are welded, bolted or riveted to the ground plate. This type of metal-to-metal mechanical attachment presents two drawbacks. First, the metal-to-metal contact points create nonlinear impedance regions that cause interference in the radio-frequency signals carried by the antenna. A troubling type of interference for a wireless base station antenna is known as passive intermodulation (PIM) interference, in which harmonics from the antenna's transmit band occur in the receive band. The nonlinear impedance regions caused by the metal-to-metal contact points are known to be a significant source of PIM interference.

The second drawback resulting from metal-to-metal contact points within the antenna is caused by contact between different types of metal, such as an aluminum ground plate and steel screws or rivets. This results in electromechanical corrosion caused by cathodic oxidation at the area where the different metals touch. This is typically observed as rusted screws or a layer of white oxidation in the area of the screws. When this occurs, the impedance characteristics of the nonlinear impedance regions change over time and may increase, which makes it difficult to design, and expensive to implement, PIM interference reduction circuits (typically called “PIM traps”) that remain effective over the life of the antenna.

Accordingly, there is a need for antennas, such as log periodic dipole antennas, that do not experience PIM interference as a result of metal-to-metal contact points between the antenna element and the ground plate. There is a further need for log periodic dipole antennas that do not experience electromechanical corrosion in regions of contact between dissimilar metals.

### SUMMARY OF THE INVENTION

The invention meets the needs described above in an antenna, such as a log periodic dipole antenna, in which some or preferably all of the mechanical attachments between cantilevered antenna elements and a ground plate do not include metal-to-metal connection points. In particular, a dielectric adhesive material, such as a sufficiently sturdy dielectric tape, is instead used to create the mechanical attachments between the antenna elements and the ground plate. Other attachments to the antenna element, such an antenna feed circuit and a signal coupler, may also be implemented with the dielectric adhesive material to avoid metal-to-metal contact points. This type of construction avoids PIM interference and electromechanical corrosion that is often caused by metal-to-metal contact points.

Generally described, the invention may be implemented as a radio-frequency antenna or a method for manufacturing a radio-frequency antenna that includes a ground plate and an array of antenna elements, such as log periodic dipole antenna elements, in which each antenna element is mechanically supported by, and capacitively coupled to, the ground plate by a dielectric adhesive layer. The ground plate has an elongated dimension and is configured for operational installation with the elongated dimension oriented vertically. In this configuration, each antenna element is cantilevered from the ground plate and the dielectric adhesive layer provides the only mechanical support for the antenna element. The antenna element typically includes one or two linear arrays of log periodic dipole antenna elements.

In addition, each antenna element typically includes a radiating element extending from a base to a tip with the base mechanically supported by and capacitively coupled to the ground plate by a first dielectric adhesive layer. Each antenna element also includes an antenna element feed circuit mechanically supported by and operatively coupled to the radiating element by a second dielectric adhesive layer. Each antenna element may also include a radio-frequency signal coupler electrically connected to the antenna element feed circuit and extending over, without electrically connecting to, the tip of the radiating element. In this configuration, the antenna element also includes a third dielectric adhesive layer mechanically supporting and capacitively coupling the signal coupler to the radiating antenna element.

More specifically described, the log periodic dipole antenna element typically includes a dual-vane radiator element and an antenna element feed circuit mechanically supported by the dual-vane radiator element. The antenna element feed circuit includes a radio-frequency transmission signal trace that is operatively coupled to the dual-vane radiator element. In particular, the antenna element feed circuit may include a microstrip printed circuit board panel that is mechanically supported by and capacitively coupled to the dual-vane radiator element by a second dielectric adhesive layer.

In a particular embodiment, the dual-vane radiator includes first and second dipole vanes that each have a base, a trunk extending from the base to a tip, and a plurality of dipole resonators extending from the trunk. These two vanes are mechanically fastened and operatively coupled to each other by one or more dielectric adhesive spacers located between the vanes. In addition, the first and second dipole vanes are disposed in a nested configuration in which the first dielectric adhesive layer is located between the base of the second dipole vane and the ground plate, and another dielectric adhesive layer is located between the base of the first dipole vane and the base of the second dipole vane.

More specifically, the antenna element feed circuit is attached to and substantially coextensive with the trunk of the first or second dipole vanes. A radio-frequency signal coupler is electrically connected to the antenna element feed circuit and extends over, without electrically connecting to, the tips of the first and second dipole vanes. In addition, a fourth dielectric adhesive layer mechanically fastens and capacitively couples the signal coupler adjacent to the tip of the first or second dipole vane. As noted above, the antenna typically includes a one or two linear arrays of these log periodic dipole antenna elements.

In view of foregoing, it will be appreciated that the present invention provides an improved log periodic dipole antenna that avoids the generation of PIM interference and electromechanical corrosion associated with metal-to-metal contact points.

### BRIEF DESCRIPTION OF THE DRAWINGS

FIG. 1 is a perspective view of a log periodic dipole antenna operationally installed on a pole as a wireless telephone base station antenna.

FIG. 2A-D are top, rear, perspective and side views of the log periodic dipole antenna of FIG. 1 with the radome removed to show the underlying antenna elements.

FIG. 3 is perspective view of two log periodic dipole antenna elements mechanically supported by and capacitively coupled to a ground plate.

FIGS. 4A-D show top, front, perspective and side views of the log periodic dipole antenna element.

FIG. 5 is an exploded perspective view of the log periodic dipole antenna element.

FIG. 6 is an enlarged cross-sectional side view of the log periodic dipole antenna element.

FIG. 7 is an exploded perspective view of an alternative configuration of the log periodic dipole antenna element.

FIG. 8 shows a perspective view of a log periodic dipole antenna with one linear array of antenna elements.

FIG. 9 is a perspective view of a log periodic dipole antenna with two linear arrays of antenna elements.

### DETAILED DESCRIPTION OF SPECIFIC EMBODIMENTS

The invention may be embodied in a wireless telephone base station including any number of antennas that each include one or more antenna elements, such as log periodic dipole antenna elements. The illustrative embodiments include log periodic dipole antenna elements that are cantilevered from a support panel that also serves as a ground plate. The antenna elements are mechanically supported by and capacitively coupled to the ground plate with a dielectric adhesive material to avoid metal-to-metal contact between the antenna elements and the ground plate. This configuration avoids the passive intermodulation (PIM) interference and electromechanical corrosion normally associated with metal-to-metal contacts in RF antennas.

These antennas are well suited to use as wireless telephone base station antennas, and with modifications that will be apparent to those skilled on the art of antenna design, may be configured to operate within any of the authorized carrier frequency bands, such as the analog cellular frequency band between 824 MHz and 894 MHz, and the PCS and GSM digital system carrier frequency bands of 1850 MHz through 1990 MHz in the United States and 1710 MHz through 2170 MHz in Europe and Japan. The details of specific PCS/GSM embodiments are shown in the drawings and described below.

More generally, log periodic dipole antennas operate over a broad frequency range and the log periodic dipole antenna is one of several antennas that fall within a class of theoretically frequency independent antenna structures. The log periodic dipole antenna has a lower frequency limit set by the longest dipole in the structure and has a high frequency limit set by the shortest dipole in the structure. A properly designed log periodic dipole antenna can operate effectively over a continuous frequency range between these end limits. The log periodic dipole antenna structure typically includes a number of dipoles configured as radiating arms having length, and often width, dimensions that vary from each other according to a logarithmic scaling rule. The dipoles in the log periodic dipole antenna structure are interconnected in series with a transmission line. The adjacent dipoles are arranged to provide a 180 degree phase shift between successive dipoles at the resonant frequency of the individual dipole. The classical feed for the log periodic dipole antenna occurs at the vertex near the smallest dipole element and the principal direction of radiation is the opposite direction of the primary wave traveling along the transmission line. In other words, the classical log period dipole antenna operates with a mode of backfire radiation.

The antenna structure in the present invention includes a radio frequency ground surface used in conjunction with the log periodic dipole antenna to enhance the antenna directivity generally in the backfire direction. A planar surface is often used for simplicity when the desired pattern shape can be achieved in this way. A non-planar ground plate may be used for beam shaping. The log periodic dipole antenna structure is often oriented, but need not necessarily be oriented, with each dipole arm extending parallel to the portion of the surface of the ground plate supporting the associated antenna element. Nevertheless, there are other configurations, such as those used for pattern shaping or other beam steering applications, in which the log periodic dipole antenna arms and the ground plate are not parallel to each other. Furthermore, the log periodic dipole antenna is not limited to having individual dipole arms extending parallel to each other, and one well known example of a non-parallel geometry is the log periodic V-dipole antenna structure. Common to all of these various geometries is a need to attach the log periodic dipole antenna elements to the ground surface (also called a ground plane or ground plate) where the attachment mechanism has both a mechanical function and an electrical capacitive coupling function at the operational frequency band.

The passive intermodulation (PIM) performance characteristics of the antenna structure is important in applications such as cellular mobile communications where more than one high RF power transmitter carrier frequency may be simultaneously present in the antenna structure during operation. Passive intermodulation products can be a significant source of interference limiting the communication system quality and capacity. Conventional log periodic dipole antennas used in conjunction with a radio frequency ground plate use a variety of conventional metal-to-metal fastening techniques, such as welding, soldering, rivets, screws, threaded studs, and the like. In contrast, the inventive construction of the antennas described below eliminates metal-to-metal contact points in the attachment of the antenna elements to the ground plate and thereby mitigates PIN interference and avoids the electromechanical corrosion often associated with metal-to-metal fasteners. These desirable characteristics are achieved in a low cost, rugged and reliable antenna that is largely amenable to mass production and suitable for many years of service in harsh environmental conditions. Of course, antennas other than log periodic dipole antenna element can also benefit from these design techniques. However, these design techniques are particularly germane to log periodic dipole antennas because the inherent size, weight and cantilevered configuration of the antenna elements have caused conventional log periodic dipole antennas to rely on metal-to-metal fasteners, such as screws or rivets, to attach the antenna elements to the ground plate.

Dipole strips for log periodic dipole antennas are often fabricated from metal sheet stock when the size and cost of the dipole strips warrant a low cost material. The material design choice is often aluminum, brass, or copper. In conventional log periodic dipole antennas, traditional fasteners extending through holes in the sheet metal are often used to establish and maintain the spacing between sheet metal dipole strips. These traditional fasteners usually include an insulator made from an insulating material such as plastic. Other custom fasteners made from an insulating material, such as a molded plastic fasteners, may snap fit to external features and obviate the need for any holes in the dipole strips. The embodiments of present invention described below, on the other hand, use dielectric foam blocks attached between two dipoles vanes with a dielectric adhesive. The foam blocks may be a continuous or segmented layer and an outdoor application generally warrants the foam layer to be closed cell.

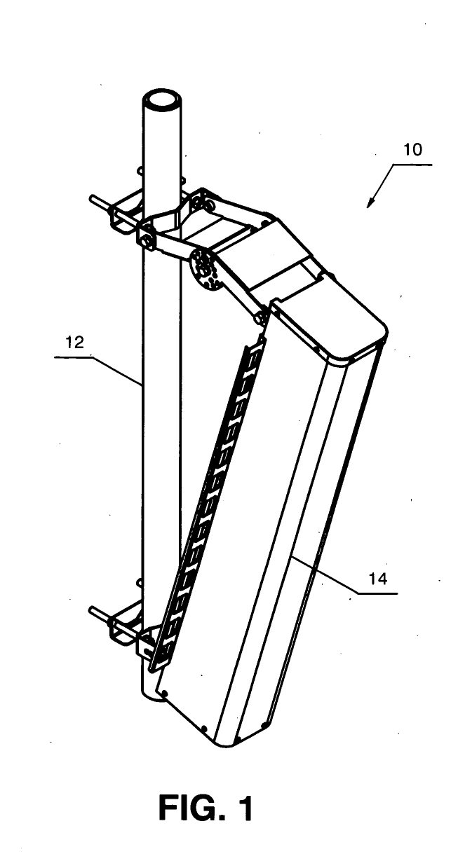

Referring now to the drawings, in which like numerals refer to like elements throughout the several figures, FIG. 1 is a perspective view a log periodic dipole antenna 10 operationally installed on a pole 12 in a typical wireless telephone antenna installation. As shown in this figure, the antenna is an elongated panel antenna installed substantially vertically with a slight downtilt, which is about 15 degrees in this illustration. Typically, the antenna is mechanically pointed downward toward the horizon as shown, and the tilt angle can be mechanically changed locally or remotely. The antenna is covered by a radome 14, which protects the internal antenna elements and adds structural integrity and rigidity to the antenna. For a particular wireless telephone base station antenna, two or three antennas are usually installed in a horizontal array as seen on many buildings and towers.

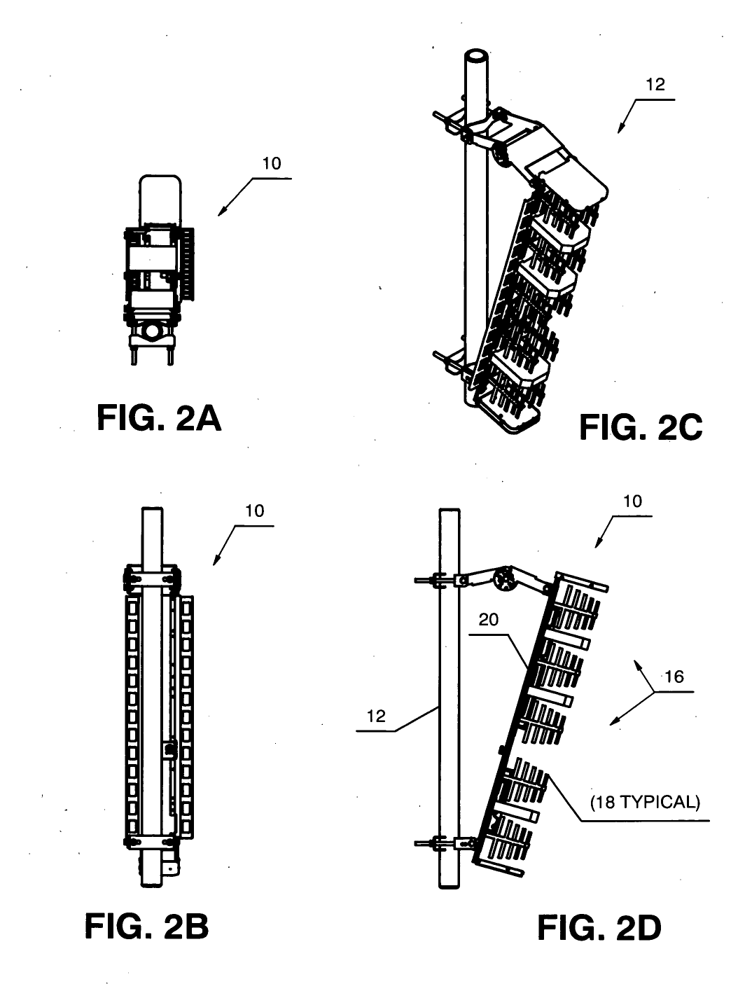

FIG. 2A-D are top, rear, perspective and side views of the log periodic dipole antenna 10 with the radome 14 removed to show the internal structure of the antenna. As shown in FIG. 2C, this particular antenna includes two parallel rows of similar planar log periodic dipole antenna elements. FIG. 2D provides a clear view of one of the linear arrays 16 with a representative one of the antenna elements 18 labeled for descriptive convenience. The antenna element 18 is cantilevered from the substantially flat elongated ground plate panel 20, which serves as a mechanical support panel and an electrical ground for the antenna. Of course, the specific embodiment shown is merely illustrative and the configuration of the array, the number and shape of the antenna elements and the shape of the ground plate, and other elements of the design can be altered as desired for different applications. In particular, the ground plate need not be strictly planar, although this configuration is conducive to mass production from sheets of stock material.

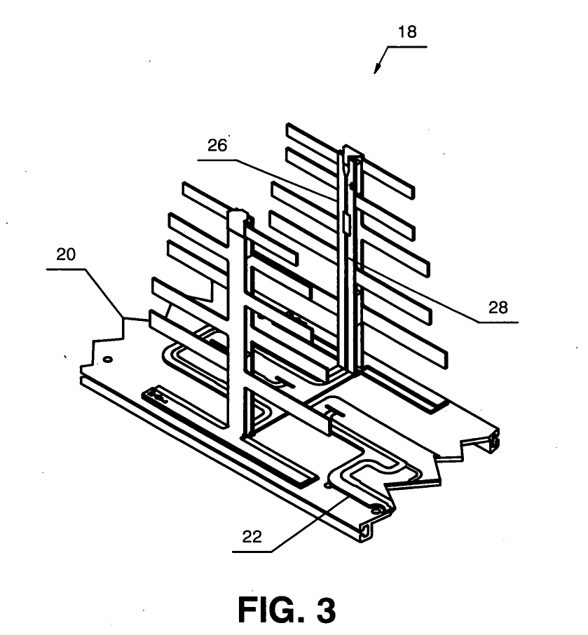

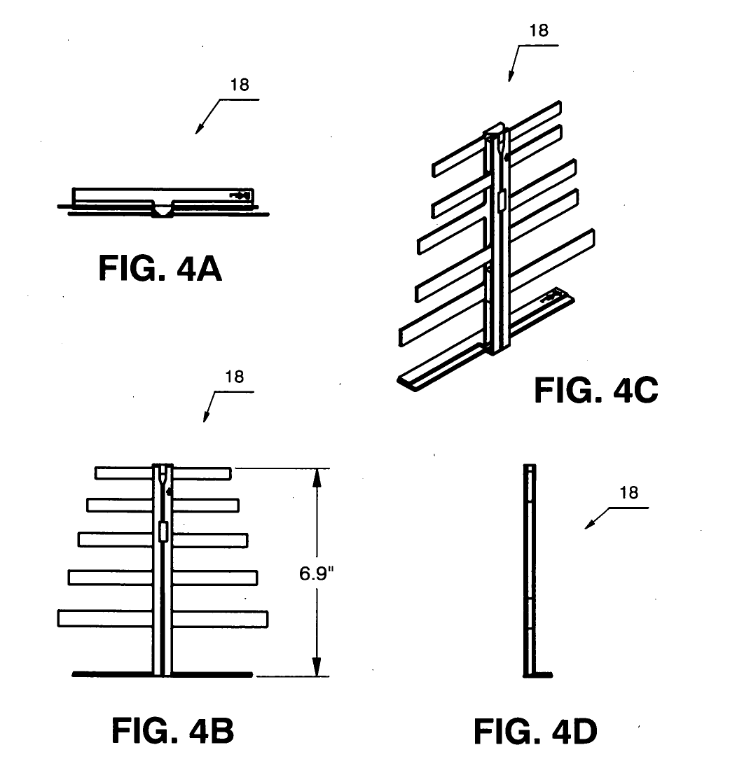

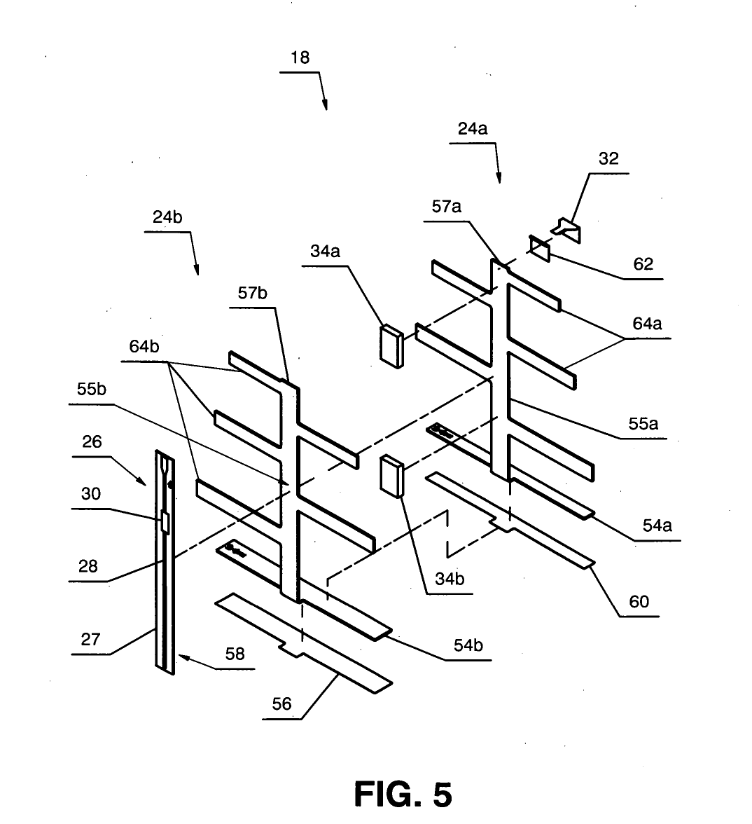

FIG. 3 is perspective view of two log periodic dipole antenna elements. FIGS. 4A-D show top, front, perspective and side views of the antenna element and FIG. 5 is an exploded perspective view of the antenna element, which in general provides a clearer view of the individual components of the antenna element. The antenna element 18 is supported by the ground plate 20. The ground plate also includes a printed circuit board 22 carrying a power distribution circuit that is electrically connected with the signal trace 28 carried on the antenna element feed circuit 26. As shown best in the exploded view of FIG. 5, the antenna element 18 is a dual-vane structure that includes first and second radiating antenna vanes 24a-b that each carry an array of laterally extending log periodic resonators arms 64a-b, respectively. The antenna elements 18 is shown substantially to scale with a height of approximately 6.9 inches (17.5 cm) as shown in FIG. 4B.

One of the vanes, the second vane 24b in this particular example, carries the antenna element feed circuit 26. The feed circuit may be implemented on a microstrip or dielectric PC board or panel 27. A microstrip PC board differs from a dielectric PC board in that the microstrip panel carries a dielectric substrate with a ground plate adhered to its rear side, whereas a dielectric panel does not carry a ground plate. In either case, the feed circuit 26 carries a conductive signal trace 28, which typically includes an impedance tuning block 30. In this particular example, the impedance tuning block matches the antenna element to a 50Ω impedance. A signal coupler 32 is electrically connected to the signal trace 28 and is capacitively coupled to one of the vanes, in this embodiment the first vane 24a, to deliver radio-frequency signals to the antenna element. In addition, a pair of dielectric foam spacers 34a-b mechanically attach and capacitively couple the vanes 24a-b to each other. Each spacer typically includes a closed-cell foam core with dielectric adhesive layers on its front and back sides.

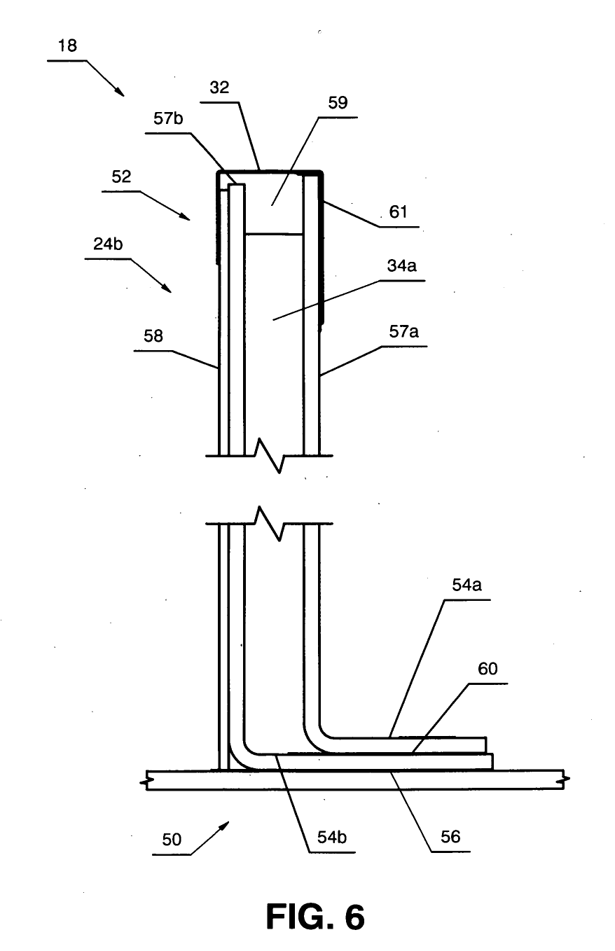

FIG. 6 is an enlarged cross-sectional side view of the log periodic dipole antenna element 18, which shows a broken cross-section side view of the antenna vanes 24a-b. The antenna element 18 extends from a base 50, which is attached to the ground plate 20, to a tip 52. More specifically, the first antenna vane 24a extends from a base 54a, up a trunk 55a, and terminates at a tip 57a. Similarly, the second antenna vane 24b extends from a base 54b, up a trunk 55b, and terminates at a tip 57b. The first and second antenna vanes 24a-b are disposed in a nested configuration with the base 54a of the first vane 24a located on top of the base 54b of the second vane 24b, which is stacked on top of the ground plate 20. The second antenna vane 24b is mechanically attached and capacitively coupled to the ground plate 20 by a first dielectric adhesive layer 56 and the first vane 24a is attached to the second antenna vane 24b by an adhesive layer 60. To avoid metal-to-metal contact points, these layers preferably provide the only mechanical support connecting the antenna element 18 to the ground plate 20. This configuration, as noted earlier, avoids PIM interference and electromechanical corrosion that can result from metal-to-metal contact points in these types of antennas.

In this particular embodiment, the antenna element feed circuit 26 is substantially coextensive with and attached to the trunk 55b of the second antenna vane 24b by a dielectric adhesive layer 58. In addition, the signal coupler 32 extends over the tips 57a-b of the antenna vanes 24a-b without physically contacting the vanes by virtue of an air gap 59 and a dielectric adhesive layer 62 that attaches the signal coupler to the first vane 24a. This configuration avoids metal-to-metal contact points, eliminates DC contact between the coupler and the antenna vanes components, and capacitively couples the signal coupler 32 to the first vane 29a to excite the antenna element for RF transmission.

In an embodiment in which the feed circuit 26 is a microstrip printed circuit board panel, the feed circuit 26 is capacitively coupled to the trunk 55b of the second antenna vane 24b because the transmission signal trace 28 and the conductive antenna vane 24a are sufficiently close together to be functionally at the same electric potential at the operational carrier frequency. In this case, an electric potential difference sufficient to support transmission signal propagation in the transmission signal trace 28 is maintained between the signal trace and the microstrip ground plate carried on the opposite side of the feed circuit 26. When the feed circuit 26 is a dielectric printed circuit board panel without an its own ground plane, on the other hand, the trunk 55b of the second antenna vane 24b serves as the ground plane for the feed circuit 26. In this embodiment, as a result, an electric potential difference sufficient to support transmission signal propagation in the transmission signal trace 28 is maintained between the signal trace and the trunk 55b of the second antenna vane 24b.

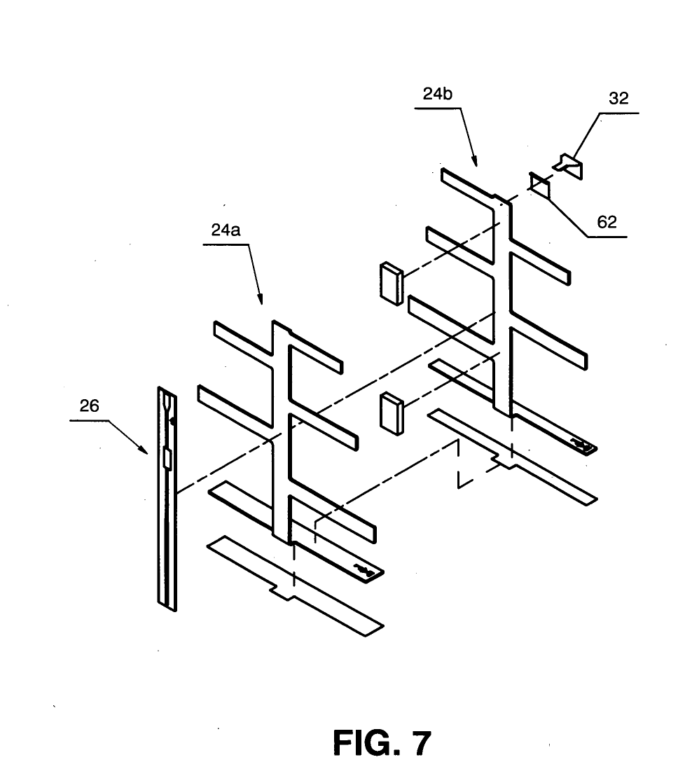

FIG. 7 is an exploded perspective view of an alternative configuration of the log periodic dipole antenna element 18, in which the positions of the first and second vanes 24a-b have been switched. This configuration is functionally equivalent to the embodiment shown in FIG. 7. With reference to FIG. 3, it should also be appreciated that the two antenna elements in this embodiment are configured to propagate in phase with each other. This is accomplished by having the antenna elements disposed in mirror-image relationship to each other. That is, the outer vane (i.e., the vane closer to the lateral edge of the ground plate 20) in each antenna element has the same resonator arm structure extending away from the trunk in the same direction. Similarly, the inner vane in each antenna element has the same resonator arm structure extending away from the trunk in the same direction. In this embodiment, if one of the two antenna elements is rotated 90 degrees about its trunk, then the antenna elements would radiate 180 degrees out of phase with each other.

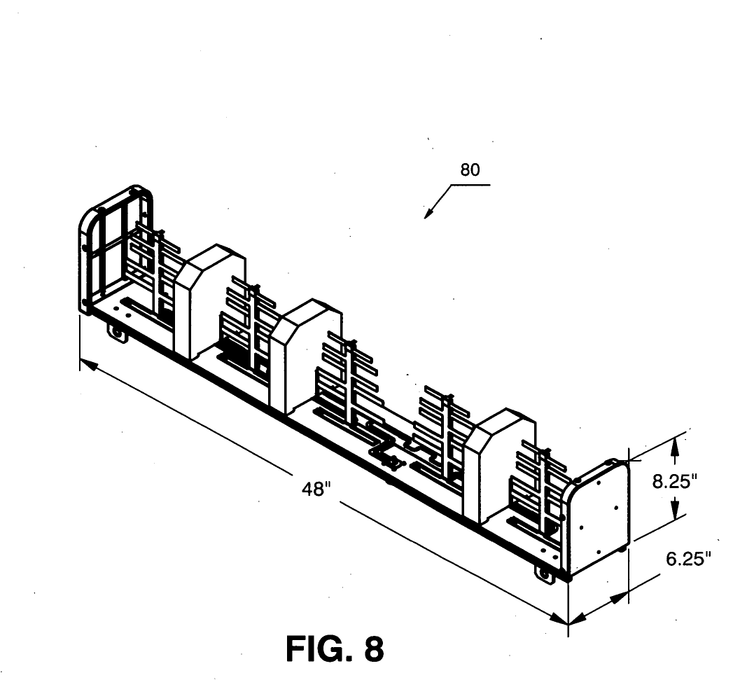

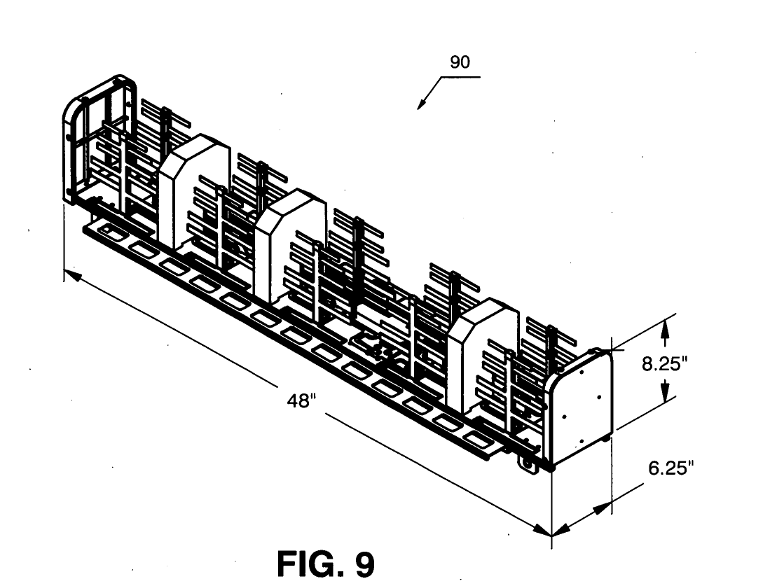

FIG. 8 shows a perspective view of a log periodic dipole antenna 80 with one linear array of antenna elements and FIG. 9 is a perspective view of a log periodic dipole antenna 90 with two linear arrays of antenna elements. Both embodiments are shown without radomes and include a number of the log periodic dipole antenna elements 18 described above. These figures are shown substantially to scale with the approximately length 48 inches (122 cm) and certain other dimensions of the antenna as indicated in the figures.

Turning now to material and additional dimensional specifications of an illustrative PCS/GSM wireless telephone base station antenna, the ground plate 20 has a substantially planar inverted tray configuration defined by two perpendicular flange sections extending along the elongated longitudinal edges of the ground plate 20, as shown best in FIG. 3. Of course, the ground plate 20 may be non-planar, for example with a creased, folded or rectangular cross-section. The ground plate may also have apertures or be configured in sections having discontinuous in localized regions so long as the configuration results in the desired RF response for the particular application.

In this particular embodiment, the ground plate 20 is formed from an aluminum sheet having a thickness of approximately one-eighth (0.125) of an inch (0.3175 cm). The ground plate is a key structural element with its thickness and inverted tray configuration selected to provide sufficient stiffness and strength. Other embodiments are possible, including those that rely on the radome 14 (shown in FIG. 1) as an additional structural element. For this type of embodiment, the ground plate can be a thinner layer of aluminum or other suitable conducting material, on the order of approximately three to ten thousandths (0.003 to 0.010) of an inch (0.76 mm to 2.54 mm).

The antenna vanes 24a-b are substantially flat or planar, and may be stamped from sheet stock in one piece from a conductive material with good bending characteristics. In the preferred embodiment, the vanes are aluminum, but other materials such as copper, brass or another suitable conductive material can be used. The adhesive layers 56, 58, 60 and 62 can be acrylic pressure-sensitive transfer adhesives, such as the dielectric adhesive tape manufactured under the trade name VHB™ by 3M Corporation located in St. Paul, Minn. with thickness values on the order of two thousandths (0.002) to five thousandths (0.005) of an inch (0.005 cm-0.013 cm). Although other dielectric adhesive systems may be used, including wet application systems, dry acrylic adhesive tape is preferred because it is easy to handle and amenable to stacking of layers.

The foam cores of the spacers 34a-b are preferably a closed-cell foam to substantially restrict moisture uptake in the antenna environment and to make the spacers amenable to wet processes, such as water jet cutting with a relatively small amount of absorption of liquids. Specifically, the spacers can be an expanded polyolefin plastic material having a typical density of 2, 4, 6, 9, or 12 lbs per cubic foot (32, 64, 96, 144 or 192 kg/m³). One such material is expanded polyethylene that is preferably cross-linked typically using radiation during manufacture to enhance the material properties. A heat activated chemical cross-linking agent can be used in other formations. One cross-linked closed cell expanded polyethylene foam using radiation is known as VultraCell™ manufactured by Vulcan Corporation, a Tennessee Corporation and a wholly owned subsidiary of Vulcan International Corporation, a Delaware Corporation. A second cross-linked closed cell expanded polyethylene foam is known as Volara™ manufactured by Voltek, a Division of Sekisui America Corporation. Voltek manufactures a variety of grades of other cross-linked, closed-cell polyolefin foam materials that can be suitable for this application. The roll type polyolefin foam materials are flexible and can take the shape of other objects to which they are bonded, which allows the antenna to be curved in one or more planes using the components described herein and conventional processing and assembly techniques.

The dielectric constant of the foam core layer is dependent on the density and the dielectric constant of the expanded material, which is utilized to form the foam core layer. Rigid, low density foams such as expanded polystyrene (EPS) in molded forms can have densities in the range of 1.25 to 2.5 lbs per cubic foot (20 to 40 kg/m³). The dielectric constant for these low density foams is 1.02 to 1.04, which is close to the dielectric constant of air (1.00). Extruded polystyrene (EPS) foam may be preferred over expanded polystyrene foam in some applications due to the reduced moisture uptake resulting from reducing the small interstitial channels that occur in the expanded type foam that use foam beads in their construction. Nevertheless, EPS foam can have sufficiently low moisture uptake for some applications. The dielectric constant of extruded cross-linked polyethylene foam with 6 lbs per cubic foot (96 kg/m³) density is typically 2.3. Other cross-linked expanded polyolefin foams can have a dielectric constant value of 1.35. One foam core layer which can be utilized is approximately one hundred ninety thousandths (0.190) of an inch (0.048 cm) thick. The lower values of dielectric constants generally have lower dissipation factors due to the lower density of the plastic material.

A rigid foam material that can be used for the foam core of the spacers 34a-b is Rohacell™, manufactured by EMKAY Plastics Ltd. in Norwich UK. Rohacell™ is a polymethacrylimide (PMI) rigid foam free from CFCs, bromine and halogen and is stated to be 100% closed cell and isotropic. The Rohacell™ foam has excellent mechanical properties, high dimensional stability under heat, is solvent resistance, and has a particularly low coefficient of heat conductivity. The strength values and the moduli of elasticity and shear are presently not exceeded by any other foamed plastic of the same gross density. The Rohacell™ foam is available in a variety of densities, including 2, 3.25, 4.68, and 6.87 lbs per cubic foot (32, 52, 75 and 110 kg/m³). The dielectric constant of Rohacell™ foam is generally lower than the flexible polyolefin family of foams for the same density. For example, a Rohacell™ foam having 4.68 lbs per cubic foot (75 kg/m³) has a dielectric constant of approximately 1.08 at 2 GHz. The Rohacell™ foam becomes thermoelastic and can therefore be shaped at a temperature of 170-190 degrees Centigrade. The required forming temperature depends on the degree of shaping and the density. Curved foam shapes can be achieved with machining or forming with heat in some cases.

The antenna element feed circuit 26 includes a transmission signal trace 28 printed on a suitable dielectric printed circuit (PC) board panel 27, which may be a microstrip or dielectric PC board. For this type of circuit operating at a carrier frequency of 1.92 GHz (which is the center frequency of the authorized PCS wireless telephone band), a typical dielectric material (e.g., PTFE Teflon®) having a dielectric constant equal to 2.2 (εᵣ=2.2) can be used to construct the PC boards. This material exhibits an effective dielectric constant of 1.85 (ε_{reff}=1.85) for printed transmission signal traces exposed to the PC board on one side and exposed to air on the other side. For this type of PC board circuit, the wavelength in the guide (λ_{g}) (i.e., the wavelength as propagating in the transmission signal trace as laid out on the PC board with one side exposed to the dielectric substrate and the other side exposed to air) is approximately 4.52 inches (11.48 cm). It is well known to someone familiar with the art of antenna design that using a substrate material having a higher dielectric constant value can reduce the overall size of the circuit. Materials with substantially higher dielectric constant values can be more expensive, can have higher RF signal losses, and can have RF power handling limitations that are a lower value due to reduced stripline trace width values. It is also desirable to have a circuit with sufficiently wide conducting trace width values and low RF signal loss characteristics for conditions of moderate to high operational RF power levels. Generally, the use of a substrate material with a low dielectric constant value is often desirable when RF power levels are a significant design consideration.

The transmission signal coupler 32 can be made from a solderable and formable material, such as copper or brass, and may be plated with a suitable solderable finish layer such as silver, tin, tin-lead alloy, tri-alloy, or other suitable metal composition. The coupler typically extends over the tips of the dipole vanes without contacting the tips by virtue of an air gap 59 and the dielectric layer 62, which eliminates DC contact between the microstrip coupler and the dipole vanes 24a-b. This dielectric layer is an adhesive layer and can be the same material as the adhesive layers in the attachment of the first base to the second base.

It should be understood that the foregoing relates only to the exemplary embodiments of the present invention, and that numerous changes may be made without departing from the spirit and scope of the invention as defined by the following claims.

1. A radio-frequency antenna comprising:
a ground plate;
a log periodic dipole antenna element extending from the ground plate; and
a first dielectric adhesive layer mechanically fastening and capacitively coupling the antenna element to the ground plate.

2. The antenna of claim 1, wherein:
the ground plate has an elongated dimension and is configured for operational installation with the elongated dimension in a substantially vertical orientation with the antenna element cantilevered from the ground plate; and
the first dielectric adhesive layer provides the only mechanical support holding the antenna element to the ground plate.

3. The antenna of claim 1, wherein the antenna element comprises a dual-vane radiator element, further comprising an antenna element feed circuit mechanically supported by the dual-vane radiator element, the antenna element feed circuit comprising a radio-frequency transmission signal trace that is operatively coupled to the dual-vane radiator element.

4. The antenna of claim 3, wherein the antenna element feed circuit comprises a microstrip printed circuit board panel or a dielectric printed circuit board panel.

5. The antenna of claim 3, wherein the antenna element feed circuit comprises a microstrip printed circuit board panel mechanically supported by and capacitively coupled to the dual-vane radiator element by a second dielectric adhesive layer.

6. The antenna of claim 3, wherein the dual-vane radiator element further comprises:
a first dipole vane comprising a base, a trunk extending from the base to a tip, and a plurality of dipole resonators extending from the trunk;
a second dipole vane comprising a base, a trunk extending from the base to a tip, and a plurality of dipole resonators extending from the trunk; and
one or more dielectric adhesive spacers located between first and second dipole vanes mechanically fastening and operatively coupling the first and second dipole vanes to each other.

7. The antenna of claim 6, wherein:
the first and second dipole vanes are disposed in a nested configuration;
the first dielectric adhesive layer is located between the base of the second dipole vane and the ground plate; and
a third dielectric adhesive layer is located between the base of the first dipole vane and the base of the second dipole vane.

8. The antenna of claim 6, wherein the antenna element feed circuit is attached to the trunk of the first or second dipole vanes.

9. The antenna of claim 6, wherein the antenna element is attached to and substantially coextensive with the trunk of the first or second dipole vanes.

10. The antenna of claim 9, further comprising a radio-frequency signal coupler electrically connected to antenna element feed circuit and extending over, without electrically connecting to, the tips of the first and second dipole vanes.

11. The antenna of claim 10, further comprising a fourth dielectric adhesive layer mechanically fastening and capacitively coupling the signal coupler adjacent to the tip of the first or second dipole vane.

12. The antenna of claim 2, wherein the ground plate supports an array of the log periodic dipole antenna elements.

13. The antenna of claim 12, wherein the array of the antenna element comprises a linear array of the log periodic dipole antenna elements extending in the elongated dimension of the ground plate.

14. The antenna of claim 12, wherein the array of the antenna element comprises two substantially parallel linear arrays of the log periodic dipole antenna elements extending in the elongated dimension of the ground plate.

15. A radio-frequency antenna comprising a ground plate and an array of antenna elements, each antenna element mechanically supported by and capacitively coupled to the ground plate by a dielectric adhesive layer, wherein the ground plate has an elongated dimension and is configured for operational installation with the elongated dimension in a substantially vertical orientation with each antenna element cantilevered from the ground plate, and wherein the dielectric adhesive layer provides the only mechanical support holding the antenna element to the ground plate.

16. The antenna of claim 15, wherein the array of the antenna element comprises a linear array of log periodic dipole antenna elements extending in the elongated dimension of the ground plate.

17. The antenna of claim 15, wherein the array of the antenna element comprises two substantially parallel linear arrays of log periodic dipole antenna elements extending in the elongated dimension of the ground plate.

18. A method for manufacturing radio-frequency antenna comprising the steps of:
providing a plurality of antenna radiators, each extending from a base to a tip;
providing ground plate having an elongated dimension and configured for operational installation with the elongated dimension in a substantially vertical orientation with each antenna radiator cantilevered by its base from the ground plate; and
attaching and capacitively coupling each antenna radiator to the ground plate with a dielectric adhesive material that provides the only mechanical support for the antenna radiator.

19. The method of claim 18, further comprising the steps of:
attaching and capacitively coupling an antenna element feed circuit to each antenna element with a dielectric adhesive layer that provides the only mechanical support for the antenna element feed circuit;
attaching a radio-frequency signal coupler to each antenna element feed circuit and extending the signal coupler over the tip of the antenna element without electrically connecting to the tip of the antenna radiator; and
capacitively coupling the signal coupler to the antenna radiator.

20. The method of claim 19, wherein the step of providing a plurality of antenna radiators further comprises the step of providing each antenna radiator in a dual-vane log periodic dipole configuration.
